(19) United States
(12) Patent Application Publication
(10) Pub. No.: US 2026/0050410 A1
(43) Pub. Date: Feb. 19, 2026

(54) INFORMATION PROCESSING METHOD, INFORMATION PROCESSING SYSTEM, AND NON-TRANSITORY COMPUTER-READABLE STORAGE MEDIUM STORING INFORMATION PROCESSING PROGRAM

(71) Applicant: Yamaha Corporation, Hamamatsu (JP)

(72) Inventor: Akira MAEZAWA, Yokohama-shi (JP)

(21) Appl. No.: 19/327,922

(22) Filed: Sep. 12, 2025

Related U.S. Application Data
(63) Continuation of application No. PCT/JP2024/009447, filed on Mar. 11, 2024.

(30) Foreign Application Priority Data
Mar. 13, 2023 (JP) 2023-038550

(51) Int. Cl. G06F 3/16; G06T 13/40; G06T 13/80

(52) U.S. Cl. CPC G06F 3/167; G06T 13/40; G06T 13/80

(57) ABSTRACT

An information processing method includes analyzing a state of a performance by a user in real space. The information processing system further includes displaying, on a display device, a performance character that performs in virtual space. The information processing system further includes controlling an action of the performance character in accordance with the state of the performance by the user.

### CROSS-REFERENCE TO RELATED APPLICATIONS

This application is a continuation application of International Application No. PCT/JP2024/009447, filed on Mar. 11, 2024, which claims priority to Japanese Patent Application No. 2023-038550 filed in Japan on Mar. 13, 2023. The entire disclosures of International Application No. PCT/JP2024/009447 and Japanese Patent Application No. 2023-038550 are hereby incorporated herein by reference.

### BACKGROUND

### Technical Field

This disclosure generally relates to a technique for supporting a performance of a musical instrument by a user.

### Background Information

Various techniques for supporting a performance of a musical instrument by a user have been proposed in the prior art. For example, International Publication No. 2021/193032 (hereinafter referred to as Patent Document 1) discloses a performance agent that executes automatic performance of a musical piece so as to follow a user's performance.

According to the technique of Patent Document 1, the user's performance is supported by an automatic performance of the performance agent. However, with recent advances in virtual reality technology, information communication technology, and the like, there is an expectation for the development of further techniques that support a user's performance in an intuitive or interactive manner. In consideration of such circumstances, an object of one aspect of the present disclosure is to intuitively or interactively support a user's performance.

### SUMMARY

In order to solve the problem described above, an information processing method according to one aspect of this disclosure comprises: analyzing a state of a performance by a user in real space; displaying, on a display device, a performance character that executes a performance action in virtual space; and controlling a guiding action of the performance character in accordance with the state of the performance by the user.

An information processing system according to one aspect of this disclosure comprises: a controller including memory storing instructions and at least one processor that implements the instructions, the instructions comprising analyzing a state of a performance by a user in real space; and displaying, on a display device, a performance character that performs in virtual space, and controlling an action of the performance character in accordance with the state of the performance by the user.

A non-transitory computer-readable storage medium storing a program according to one aspect of this disclosure executes by at least one processor of a computer system to perform a video processing method, the video processing method comprising: analyzing a state of a performance by a user in real space; and displaying, on a display device, a performance character that performs in virtual space, and controlling an action of the performance character in accordance with the state of the performance by the user.

### BRIEF DESCRIPTION OF THE DRAWINGS

FIG. 1 is a block diagram of a performance system according to a first embodiment.

FIG. 2 is a block diagram illustrating a functional configuration of an information processing system.

FIG. 3 is a schematic diagram of a guide image.

FIG. 4 is a schematic diagram of a performance character.

FIG. 5 is a block diagram of a display control unit.

FIG. 6 is an explanatory diagram of a guiding action.

FIG. 7 is a flowchart of an action control process.

FIG. 8 is a block diagram of a performance system according to a second embodiment.

### DETAILED DESCRIPTION OF EMBODIMENTS

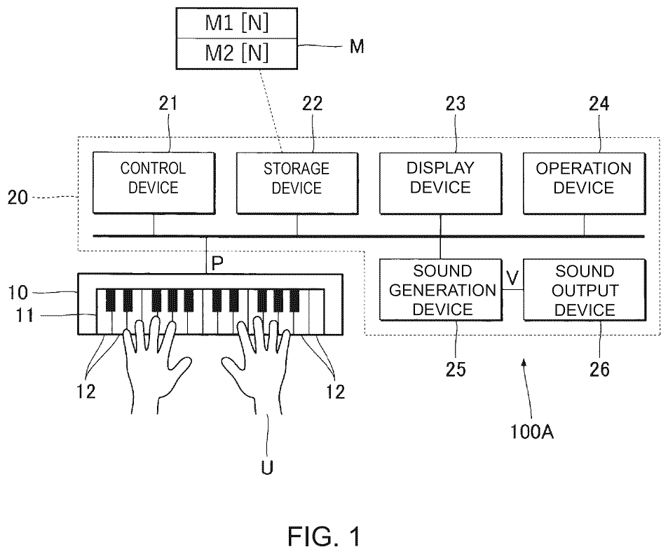

FIG. 1 is a block diagram illustrating the configuration of a performance system 100A according to the first embodiment. The performance system 100A of the first embodiment is a computer system that supports a performance of a musical piece (hereinafter referred to as “target musical piece”) by a user U. The performance system 100A comprises a performance device 10 and an information processing system 20. The performance device 10 is connected to the information processing system 20 by wire or wirelessly. The information processing system 20 can be installed in the performance device 10. The performance device 10 can be interpreted as an element constituting the information processing system 20.

The performance device 10 is an input device that receives a performance by the user U of a target musical piece. The performance device 10 is a Musical Instrument Digital Interface (MIDI) controller equipped with a keyboard 11, for example. The keyboard 11 comprises a plurality of keys 12 corresponding to different pitches. The user U sequentially operates the keys 12 to perform the target musical piece.

The target musical piece of the first embodiment includes a melody part and an accompaniment part. The melody part is a performance part composed of melody sounds of the target musical piece, and the accompaniment part is a performance part composed of accompaniment sounds of the target musical piece. The user U uses the performance device 10 to play the melody part. The melody part is one example of a “first part” and the accompaniment part is one example of a “second part.”

The performance device 10 outputs, to the information processing system 20, performance data P representing the performance by the user U. The performance data P are event data conforming to the MIDI standard, for example. Specifically, the performance data P specify the pitch corresponding to the key 12 operated by the user U. With each operation by the user U, the performance data P are transmitted in sequence from the performance device 10.

The information processing system 20 is a computer system that analyzes and supports the performance of the target musical piece by the user U. The information processing system 20 is realized by an information device such as a smartphone, a tablet terminal, or a personal computer. The information processing system 20 comprises a control device 21, a storage device 22, a display device 23, an operation device 24, a sound generation device 25, and a sound output device 26. Note that the information processing system 20 can be realized as a single device, or as a plurality of devices which are separately configured.

The control device 21 is one or a plurality of processors that control each element of the information processing system 20. Specifically, the control device 21 comprises one or more types of processors, such as a CPU (Central Processing Unit), a GPU (Graphics Processing Unit), an SPU (Sound Processing Unit), a DSP (Digital Signal Processor), an FPGA (Field Programmable Gate Array), an ASIC (Application Specific Integrated Circuit), and the like.

The storage device 22 comprises one or more memory units for storing a program that is executed by the control device 21 and various data that are used by the control device 21. A known storage medium, such as a magnetic storage medium or a semiconductor storage medium, or a combination of a plurality of various types of storage media can be used as the storage device 22. Note that, for example, a portable storage medium that is attached to/detached from the information processing system 20 or a storage medium (for example, cloud storage) that the control device 21 can access via a communication network can also be used as the storage device 22.

The storage device 22 stores music data M. The music data M specify a time series (that is, a musical score) of musical notes that constitute the target musical piece. The music data M of the first embodiment are composed of melody data M1 specifying each note of the melody part, and accompaniment data M2 specifying each note of the accompaniment part. The melody data M1 and the accompaniment data M2 are time-series data in which are arranged musical note data N that specify notes to instruct a performance, and time data that specify the time point at which each piece of the note data N are to be read. The music data M are files (SMF: Standard MIDI File) in a format conforming to the MIDI standard, for example.

The display device 23 displays images under the control of the control device 21. For example, various display panels such as a liquid-crystal display panel or an organic EL (electroluminescent) panel are employed as the display device 23. The operation device 24 is an instruction input device that receives instructions from the user U. For example, an operator that is operated by the user U, or a touch panel integrally configured with the display device 23, is used as the operation device 24. Note that the display device 23 or the operation device 24 that is separate from the information processing system 20 can be connected to the information processing system 20 wirelessly or by wire.

The performance data P generated by the performance device 10 and the note data N of the accompaniment data M2 are sequentially supplied to the sound generation device 25. The sound generation device 25 generates an audio signal V representing a waveform of a musical sound specified by the performance data P and the note data N. That is, an audio signal V is generated that represents a mixed sound of the musical sound of the melody part played by the user U and the musical sound of the accompaniment part of the target musical piece. Note that the control device 21 can execute a program to realize the function of the sound generation device 25.

The sound output device 26 reproduces the musical sound represented by the audio signal V. For example, a speaker or headphones are used as the sound output device 26. Illustrations of a D/A converter that converts the audio signal V from digital to analog and of an amplifier that amplifies the audio signal V have been omitted. Note that the sound output device 26 that is separate from the information processing system 20 can be connected to the information processing system 20 wirelessly or by wire.

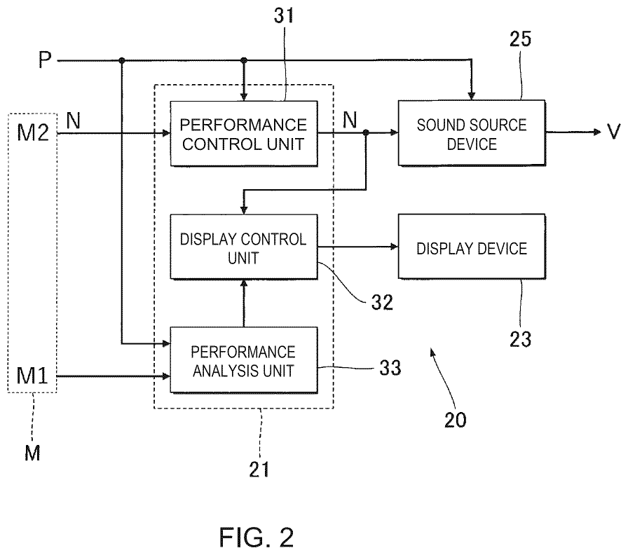

FIG. 2 is a block diagram illustrating a functional configuration of the information processing device 20. The control device 21 executes a program that is stored in the storage device 22 to realize a plurality of functions (performance control unit 31, display control unit 32, performance analysis unit 33) for analyzing and supporting the performance by the user U.

The performance control unit 31 is a sequencer that sequentially outputs, to the sound generation device 25, the note data N of the accompaniment data M2 of the music data M. That is, the performance control unit 31 instructs the sound generation device 25 to generate each musical sound of the accompaniment part specified by the accompaniment data M2. The performance data P generated by the performance device 10 are sequentially supplied to the sound generation device 25, in parallel with the supply of the note data N by the performance control unit 31. Accordingly, the musical sound of the melody part played by the user U and the musical sound of the accompaniment part of the target musical piece are reproduced in parallel by the sound output device 26.

The performance control unit 31 variably controls the output time point of the note data N to the sound generation device 25 such that the reproduction of the musical sound of the accompaniment part follows the performance by the user U. The time point at which the user U plays each note of the melody part of the target musical piece changes dynamically due to the musical expression intended by the user U or the lack of playing technique of the user U. Accordingly, the time point at which the performance control unit 31 outputs each piece of the note data N of the accompaniment data M2 to the sound generation device 25 is also variable.

Specifically, the performance control unit 31 estimates the time point (hereinafter referred to as “performance time point”) at which the user U is currently playing within the target musical piece by analyzing a time series of the performance data P. For example, the performance control unit 31 compares the melody data M1 of the music data M and the time series of the performance data P to estimate the performance time point. The estimation of the performance time point is sequentially executed in parallel with the performance of the melody part by the user U. For example, any known audio analysis technique (score alignment), such as that disclosed in Japanese Laid Open Patent Application No. 2015-79183, can be adopted for the estimation of the performance time point. The performance control unit 31 outputs each piece of the note data N to the sound generation device 25 such that the generation of the accompaniment part by the sound generation device 25 is synchronized with the progress of the performance time point. Accordingly, the reproduction of the musical sound of the melody part played by the user U and the reproduction of the musical sound of the accompaniment part of the target musical piece are synchronized with each other.

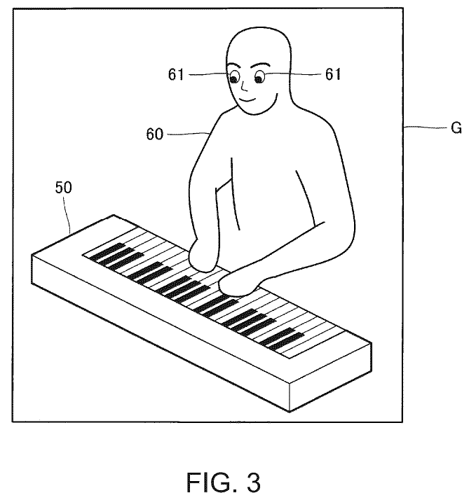

The display control unit 32 of FIG. 2 displays, on the display device 23, an image (hereinafter referred to as “guide image G”) for supporting the performance of the target musical piece by the user U. FIG. 3 is a schematic view of the guide image G. The guide image G is an animated moving image containing a virtual instrument 50 and a performance character 60.

The virtual instrument 50 and the performance character 60 are virtual objects placed in a virtual space. The virtual instrument 50 is a virtual keyboard instrument. On the other hand, the performance character 60 is a human-like object (agent) having an appearance that mimics a performer playing the virtual instrument 50 in the virtual space. Specifically, the performance character 60 of the first embodiment is a virtual performer that plays the accompaniment part of the target musical piece in the virtual space. The performance character 60 is located in the virtual space, whereas the user U is located in real space.

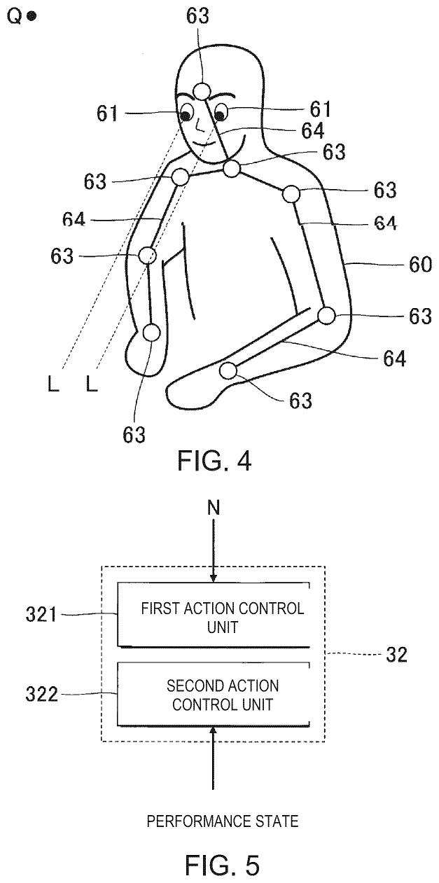

FIG. 4 is an explanatory diagram of the performance character 60. The performance character 60 is a three-dimensional object including both arms, a chest, and a head. Eyes 61 (right eye and left eye) are provided to the head of the performance character 60. Accordingly, a line of sight L is defined for the performance character 60.

The skeleton of the performance character 60 is composed of a plurality of control points 63 and a plurality of connecting parts 64. Each of the control points 63 is a point corresponding to a joint of the performance character 60 and can move within the virtual space. The connecting parts 64 are line segments that connect the control points 63 to each other. The position of each of the control points 63 and the angle of the connecting parts 64 with respect to each of the control points 63 can be changed to control an action of the performance character 60.

An observation point Q is set in the virtual space. The observation point Q is a point from which the virtual space is observed. Specifically, a virtual camera is placed at the observation point Q in the virtual space. The virtual camera is a virtual imaging device that captures an image of the virtual space. The guide image G is a moving image of the virtual space captured by the virtual camera. The display control unit 32 generates image data of the guide image G by known image processing, such as 3D rendering, and outputs the image data to the display device 23. Accordingly, the display device 23 displays the guide image G showing the state in which the performance character 60 plays the virtual instrument 50 as viewed from the observation point Q. As can be understood from the foregoing explanation, the observation point Q corresponds to the viewpoint of the user U in the virtual space.

FIG. 5 is a block diagram showing the functional configuration of the display control unit 32. The display control unit 32 of the first embodiment includes a first action control unit 321 and a second action control unit 322.

The first action control unit 321 controls the action (hereinafter referred to as “performance action”) of the performance character 60 playing the virtual instrument 50. Specifically, the first action control unit 321 links the performance action of the performance character 60 with the reproduction of the accompaniment part. Specifically, the performance character 60 sways the body to the rhythm of the accompaniment part, and, when reproducing the musical sound corresponding to each note of the accompaniment part, the performance character 60 executes a key depression action.

As described above, the reproduction of the musical sound of the accompaniment part follows the performance by the user U. Accordingly, the first action control unit 321 controls the performance action of the performance character 60 playing the accompaniment part so as to follow the performance of the melody part by the user U. According to the configuration described above, the user U can perceive the sensation that the performance character 60 is playing the accompaniment part of the target musical piece. As described above, the reproduction of the musical sound of the melody part played by the user U and the reproduction of the musical sound of the accompaniment part are synchronized with each other. Therefore, according to the first embodiment, it is possible to cause the user U to perceive the sensation as if the user is playing the target musical piece together with the performance character 60 in a cooperative ensemble or a duet.

The first action control unit 321 controls each of the control points 63 and each of the connecting parts 64 of the performance character 60 in accordance with the note data N output by the performance control unit 31, thereby linking the performance action of the performance character 60 with the reproduction of the accompaniment part. Specifically, the first action control unit 321 generates control data corresponding to the note data N output by the performance control unit 31. The control data specify the position of each of the control points 63 and the angle of the connecting parts 64 with respect to each of the control points 63

For example, a trained model is used for the generation of control data corresponding to the note data N. A trained model is a statistical predictive model in which the relationship between the note data N and the control data has been learned through machine learning. The first action control unit 321 processes the note data N, which are sequentially output by the performance control unit 31, using a trained model to generate control data, and controls the performance action of the performance character 60 in accordance with the control data. The trained model is composed of a deep neural network, such as a convolutional neural network or a recurrent neural network. For example, a known technique disclosed in Japanese Laid Open Patent Application No. 2019-139294 is used for the generation of the control data in accordance with the note data N.

The second action control unit 322 of FIG. 5 controls an action (hereinafter referred to as “guiding action”) of the performance character 60 guiding the performance by the user U. A guiding action is, for example, movement of the body of the performance character 60 or a change in the facial expression of the performance character 60. A guiding action is an action related to the performance of the melody part by the user U. That is, a guiding action is an action that is not directly related to the performance (performance action) of the accompaniment part of the performance character 60 itself. It can be said that a guiding action is an action with fewer changes in the control points 63 or the connecting parts 64 compared to a performance action.

The performance analysis unit 33 of FIG. 2 analyzes the state (hereinafter referred to as “performance state”) of the performance by the user U. Specifically, the performance analysis unit 33 processes the performance data P output by the performance device 10 to analyze the performance state. For example, the performance analysis unit 33 compares the melody data M1 of the target musical piece and the time series of the performance data P to analyze the performance state.

The second action control unit 322 controls the guiding action of the performance character 60 in accordance with the performance state of the user U. For example, the second action control unit 322 causes the performance character 60 to execute a specific guiding action when a prescribed condition (hereinafter referred to as “action condition”) is met regarding the performance state. As described above, the performance action is an action controlled in accordance with the accompaniment part, and the guiding action is an action controlled in accordance with the performance state of the user U. Specific examples of the performance state and the guiding action will be listed below.

The action condition in example action 1a is the performance of the melody part by the user U stopping for a prescribed period of time. That is, the performance analysis unit 33 determines whether the performance by the user U has stopped for a prescribed period of time. Specifically, when a prescribed time has elapsed since the point in time at which the melody data M1 instructed the sounding of a specific note without the performance data P corresponding to said note being output from the performance device 10, the performance analysis unit 33 determines that the performance by the user U has stopped.

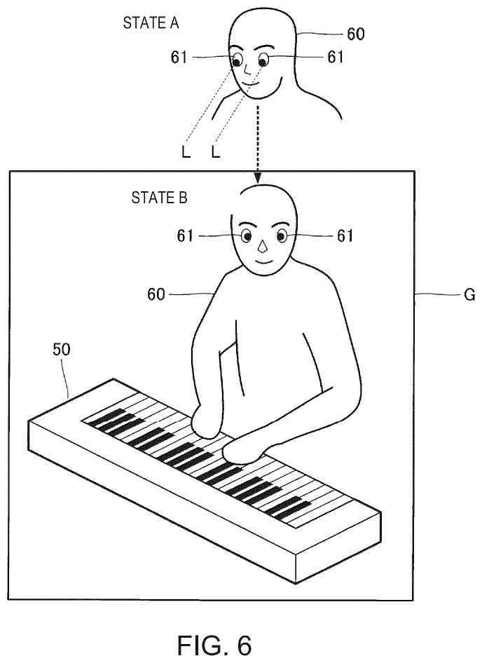

When the performance by the user U has stopped for a prescribed period of time, the second action control unit 322 causes the performance character 60 to execute a guiding action of moving the line of sight L toward the observation point Q in the virtual space. Specifically, as shown in FIG. 6, the guiding action of the example action 1a is an action of changing the line of sight L of the performance character 60 from state A directed toward the virtual instrument 50 to state B directed toward the observation point Q. State B is a state in which the head and the line of sight L of the performance character 60 are turned toward the virtual user U in the virtual space. The second action control unit 322 controls the orientation of the head of the performance character 60 to realize the guiding action described above.

The guiding action of the example action 1a is an action of the performance character 60 glancing at the user U to urge the user U to proceed with the performance. The user U, having visually confirmed the guiding action of example action 1a, can ascertain, intuitively or interactively, that the user U should proceed with the performance of the melody part.

The action condition in example action 1b is the performance of the melody part by the user U coming to an end. Specifically, the performance analysis unit 33 determines whether the last note specified by the melody data M1 has been played by the user U.

When the performance of the melody part ends, the second action control unit 322 causes the performance character 60 to execute a guiding action of moving the line of sight L toward the observation point Q in the virtual space. That is, the guiding action of the example action 1b is an action of the performance character 60 notifying the user U that the ensemble has ended. The user U, having visually confirmed the guiding action of example action 1b, can ascertain, intuitively or interactively, that the performance of the melody part has ended.

As can be understood from the explanations of the example actions 1a and 1b, the guiding action of moving the line of sight L of the performance character 60 toward the observation point Q is recognized by the user U as an action of the performance character 60 glancing at the user U. Therefore, the user U, having visually confirmed the guiding action, can ascertain, intuitively or interactively, what the user U should pay attention to regarding their own performance.

In example action 1c, the second action control unit 322 causes the performance character 60 to execute a guiding action of signaling the start of the performance of the melody part by the user U. The second action control unit 322 references the melody data M1 to identify the starting time point of the performance. Then, the second action control unit 322 causes the performance character 60 to execute a guiding action of shaking the head up and down at the time point at which the performance of the melody part starts at the beginning of the target musical piece, for example. In addition, the second action control unit 322 causes the performance character 60 to execute a guiding action of shaking the head up and down at the time point at which the performance of the melody part is restarted after a rest of a length of time longer than a prescribed value in the middle of the target musical piece. Therefore, the user U can ascertain, intuitively or interactively, the time point at which the performance of the melody part should be started.

The action condition in example action Id is the tempo of the performance of the melody part by the user U fluctuating unstably. Specifically, the performance analysis unit 33 periodically identifies the tempo of the performance of the user U, and determines presence/absence of temporal fluctuation in the performance tempo. For example, the performance analysis unit 33 determines that the performance tempo is unstably fluctuating when the variance of the performance tempo exceeds a prescribed value, and determines that the performance tempo is stable when the variance of the performance tempo is below the prescribed value.

When the performance tempo is fluctuating, the second action control unit 322 causes the performance character 60 to execute a conducting action as the guiding action. Specifically, a conducting action is a guiding action of swinging one arm (or both arms) of the performance character 60 at a period corresponding to a standard performance tempo specified by the music data M. Therefore, the user U, having visually confirmed the guiding action, can ascertain, intuitively or interactively, that the user's performance tempo is unstable, as well as ascertain the standard performance tempo of the target musical piece.

The action condition in example action 1e is the user U hesitating over the performance of the melody part. A situation in which the user U hesitates over a performance is, for example, a situation in which the user U is uncertain about the performance or a situation in which the user U cannot accurately ascertain which part of the target musical piece should be played. For example, (1) when the performance tempo of the user U is slower than the standard performance tempo, (2) when the time point at which a note is played is delayed from the time point of the note as specified by the melody data M1, or (3) when the performance by the user U is stopped for a prescribed period of time, the performance analysis unit 33 determines that the user U is hesitating over the performance.

When the user U is hesitating over the performance, the second action control unit 322 causes the performance character 60 to execute a guiding action of encouraging the user U to play. For example, the second action control unit 322 swings the head or the arms of the performance character 60 at a period corresponding to a standard performance tempo specified by the music data M. Therefore, the user U, having visually confirmed the guiding action, can ascertain, intuitively or interactively, that the user should play more proactively and confidently.

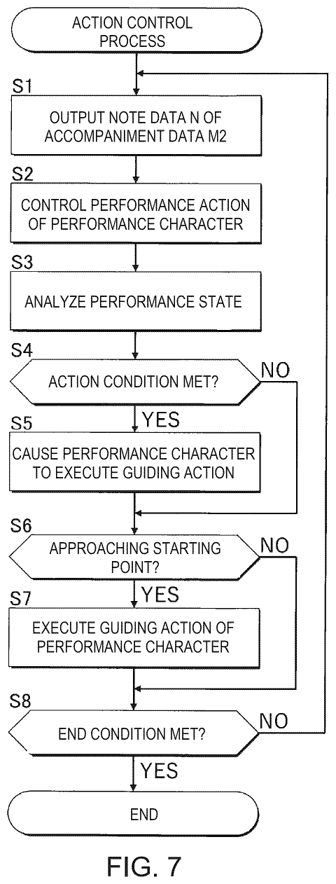

FIG. 7 is a flowchart of a process (hereinafter referred to as “action control process”) executed by the control device 21 to control the performance character 60. The action control process is started in accordance with an instruction from the user U issued to the operation device 24.

When the action control process is started, the control device 21 (performance control unit 31) outputs the note data N of the accompaniment data M2 to the sound generation device 25 (S1). The sound generation device 25 generates an audio signal V representing the musical sound specified by the note data N and the musical sound specified by the performance data P. Accordingly, the musical sound of the melody part played by the user U and the musical sound of the accompaniment part of the target musical piece are reproduced in parallel from the sound output device 26. In addition, the control device 21 (display control unit 32) causes the performance character 60 to proceed with the performance action in accordance with the note data N output to the sound generation device 25 (S2).

The control device 21 (performance analysis unit 33) analyzes the performance state of the user U (S3) and determines whether an action condition is met with respect to the performance state (S4). If an action condition is met (S4: YES), the control device 21 (display control unit 32) causes the performance character 60 to execute the guiding action (S5). On the other hand, if an action condition is not met (S4: NO), the performance character 60 does not execute the guiding action.

The control device 21 (display control unit 32) determines whether the time is approaching the time point at which the performance of the melody part should start (S6). Specifically, the control device 21 determines whether the time has reached a prescribed time before the first note of the target musical piece, or before a note after a long rest. If the time point at which the performance of the melody part should start has approached (S6: YES), the control device 21 (display control unit 32) causes the performance character 60 to execute the guiding action of signaling the start of the performance of the melody part (S7).

The control device 21 determines whether a prescribed end condition has been met (S8). An end condition is, for example, that a prescribed period of time has elapsed from the end of the performance of the target musical piece, or that an end of the performance has been instructed through an operation on the operation device 24. If the end condition is not met (S8: NO), the control device 21 causes the process to proceed to step S1. That is, the process illustrated above (S1-S7) is repeated until the end condition is met. If the end condition is met (S8: YES), the control device 21 ends the action control process.

As described above, in the first embodiment, the actions of the performance character 60 performing in the virtual space are controlled in accordance with the performance state of the user U in real space. Therefore, the user U can smoothly proceed with the performance while checking the actions of the performance character 60. That is, it is possible to intuitively or interactively support the performance by the user U. In particular, in the first embodiment, the performance character 60 executes the guiding action when an action condition is met with respect to the performance by the performer U. Therefore, the user U can ascertain, intuitively or interactively, that an action condition has been met with respect to the performance of the user U. As described above, according to the first embodiment, it is possible to provide to the user U a special customer experience of performing interactively with the performance character 60.

The second embodiment of the present disclosure will be described. In each of the embodiments illustrated below, elements that have the same functions as those in the first embodiment have been assigned the same reference symbols used to describe the first embodiment and detailed descriptions thereof have been appropriately omitted.

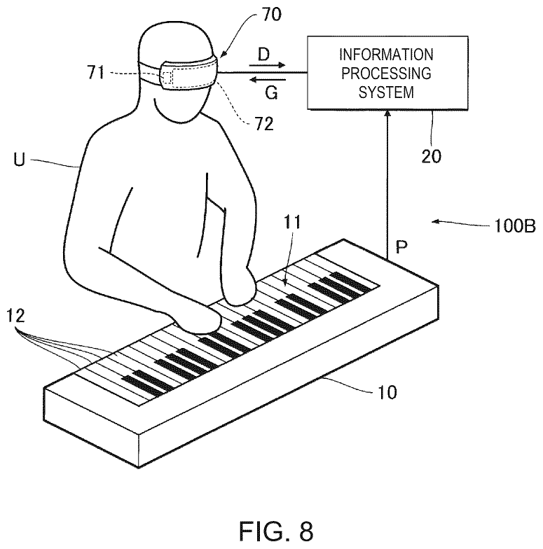

FIG. 8 is a block diagram of a performance system 100B according to the second embodiment. The performance system 100B of the second embodiment comprises a display unit 70 in addition to the performance device 10 and the information processing system 20 that are the same as those of the first embodiment.

The display unit 70 is a video device (HMD: Head Mounted Display) that is mounted on a head of the user U. For example, a goggle-type or eyeglass-type HMD is used as the display unit 70. As shown in FIG. 8, the display unit 70 comprises a detection device 71 and a display device 72.

The detection device 71 is a sensor that outputs a detection signal D corresponding to the orientation of the display unit 70. Specifically, the detection device 71 comprises a sensor such as a gyro sensor that detects angular velocity or an acceleration sensor that detects acceleration. As described above, since the display unit 70 is mounted on the head of the user U, the detection signal D generated by the detection device 71 can also be expressed as a signal representing the orientation of the head of the user U.

The display device 72 displays an image under the control of the information processing system 20. For example, various display panels such as a liquid-crystal display panel or an organic EL display panel are employed as the display device 72. The display device 72 is a non-transmissive display panel that does not transmit light arriving from real space, and is placed in front of both eyes of the user U.

The display control unit 32 of the second embodiment displays the guide image G on the display device 72 of the display unit 70. The guide image G of the second embodiment is a stereoscopic video composed of a right-eye image and a left-eye image. Therefore, the user U perceives three-dimensionality in the virtual instrument 50 and the performance character 60. As described above, since the guide image G is displayed on the display device 72 in the second embodiment, the display device 23 can be omitted.

The display control unit 32 controls the position and orientation of a virtual camera (observation point Q) in the virtual space in accordance with the detection signal D supplied from the detection device 71. Accordingly, a virtual line of sight (hereinafter referred to as “observation line of sight”) of the user U in the virtual space is controlled in accordance with the orientation of the head of the user U detected by the detection device 71. The observation line of sight corresponds to the optical axis of the virtual camera.

The display control unit 32 of the second embodiment controls the actions of the performance character 60 displayed on the display device 72 in the same manner as in the first embodiment. For example, the display control unit 32 controls the guiding actions of the performance character 60 in the same manner as in the example actions 1a to 1e described above. Therefore, the same effects as those of the first embodiment can be realized by the second embodiment.

In addition, the display control unit 32 (second action control unit 322) of the second embodiment causes the performance character 60 to execute an action (hereinafter referred to as “reaction action”) of reacting to the behavior of the user U. Specifically, the display control unit 32 controls the reaction action of the performance character 60 in accordance with the observation line of sight of the user U. Specific examples of reaction actions are shown below.

When a state in which the observation line of sight is directed toward the head of the performance character 60 is continued for a prescribed period of time, the second action control unit 322 causes the performance character 60 to execute a reaction action of moving the line of sight L toward the observation point Q in the virtual space. A state in which the observation line of sight is directed toward the head of the performance character 60 means a state in which the user U is staring at the performance character 60. Therefore, the reaction action of the example action 2a corresponds to an action in which the performance character 60 stares back at the user U in the virtual space, or an action in which the performance character 60 looks back at the user U.

When the observation line of sight is swung up and down while directed toward the performance character 60, the second action control unit 322 causes the performance character 60 to execute an action of shaking the head up and down. Swinging of the observation line of sight means a state in which the user U shakes their own head. Therefore, the reaction action of the example action 2b corresponds to an action of the performance character 60 shaking the head in synchronization with the user U in the virtual space.

The performance control unit 31 can control the rate of progress (that is, the performance tempo) of the accompaniment part in accordance with the period of the swinging of the observation line of sight. For example, the performance control unit 31 increases the performance tempo as the period of the swinging of the observation line of sight becomes shorter. Specifically, the performance control unit 31 controls the performance tempo of the accompaniment part such that the beats of the accompaniment part fall on the end points of the swinging of the observation line of sight. According to the example action 2b, it is possible to give the user U the sensation that the performance character 60 is playing in synchronization with the shaking of the head of the user U.

Specific modified embodiments to be added to each of the embodiments exemplified above are illustrated below. Two or more embodiments arbitrarily selected from the following examples can be appropriately combined insofar as they are not mutually contradictory.

(1) The content of the guiding action executed by the performance character 60 is not limited to the examples described above. In addition, any combination of an action condition that triggers the guiding action, and the guiding action executed by the performance character 60, can be freely selected and is not limited to the examples in each of the above-mentioned embodiments. For example, the performance character 60 can execute the following guiding actions.

As illustrated in the following aspects, the second action control unit 322 causes the performance character 60 to execute a guiding action of offering advice related to the performance to the user U.

According to a first aspect, when the performance by the user U stops, the second action control unit 322 causes the performance character 60 to execute a guiding action of notifying the pitch that should be played by the user U. Specifically, the second action control unit 322 causes the performance character 60 to execute a guiding action of speaking while directing the line of sight L toward the observation point Q. In parallel with the guiding action of the performance character 60, the second action control unit 322 identifies, from the melody data M1, the pitch that the user U should play next, and causes the sound output device 26 to reproduce a voice notifying the pitch. For example, a voice such as “play ‘C’ next” is reproduced form the sound output device 26. Therefore, it is possible to give the user U the sensation that the performance character 60 is presenting the pitch that should be played next by speaking. That is, it is possible to provide the user U with a unique customer experience of being taught how to perform by the performance character 60.

According to a second aspect, when the performance by the user U stops, the second action control unit 322 causes the performance character 60 to execute a guiding action of encouraging the user U to play. Specifically, the second action control unit 322 causes the performance character 60 to execute a guiding action of speaking while directing the line of sight L toward the observation point Q. In parallel with the guiding action, the second action control unit 322 causes the sound output device 26 to reproduce a voice, such as “Let's try playing more joyfully.” That is, it is possible to provide the user U with a unique customer experience of being motivated by the performance character 60 to continue playing.

According to a third aspect, when the user U plays a pitch that is different from the pitch specified by the melody data M1, the second action control unit 322 causes the performance character 60 to execute a guiding action of notifying the performance mistake. Specifically, the second action control unit 322 causes the performance character 60 to execute a guiding action of speaking while directing the line of sight L toward the observation point Q. In parallel with the guiding action, the second action control unit 322 causes the sound output device 26 to reproduce a voice notifying the user U of the performance mistake. For example, a voice such as “the ‘C’ note you played should have been ‘D’′ is reproduced form the sound output device 26. That is, it is possible to provide the user U with a unique customer experience of being taught how to perform by the performance character 60.

According to a fourth aspect, when the performance of the melody part by the user U ends, the second action control unit 322 causes the performance character 60 to execute a guiding action of notifying an evaluation of the immediately preceding performance. Specifically, the second action control unit 322 causes the performance character 60 to execute a guiding action of speaking while directing the line of sight L toward the observation point Q. In parallel with the guiding action of the performance character 60, the second action control unit 322 evaluates the immediately preceding performance by the user U and causes the sound output device 26 to reproduce a voice notifying the user U of the evaluation result. For example, a voice such as “That performance scored 50 points!” is reproduced form the sound output device 26. In addition, the second action control unit 322 can cause the sound output device 26 to reproduce a voice suggesting the user U which musical piece to play next. For example, a musical piece that is similar in tune to the target musical piece played immediately before by the user U is suggested to the user U. As described above, it is possible to provide the user U with a unique customer experience of enjoying performance of musical pieces together with the performance character 60.

As illustrated in the following additional aspects, the second action control unit 322 causes the performance character 60 to execute a reaction action in response to the user U. The reaction action is an action of changing the facial expression of the performance character 60 to facial expressions corresponding to various emotions, such as “happiness” and “sadness.” The reaction action is one example of a “guiding action.”

According to a first additional aspect, the second action control unit 322 causes the performance character 60 to execute a reaction action corresponding to the length of time (hereinafter referred to as “performance duration”) that the user U was able to play the melody part without making a performance mistake. For example, the second action control unit 322 causes the facial expression of the performance character 60 to approach that of “happiness” as the performance duration increases. According to the aspect described above, it is possible to provide the user U with a unique customer experience of being motivated by the performance character 60 to reduce performance mistakes.

According to a second additional aspect, the second action control unit 322 causes the performance character 60 to execute a reaction action corresponding to the number of performance mistakes made by the user U. For example, the second action control unit 322 causes the facial expression of the performance character 60 to approach that of “sadness” or “anger” as the number of performance mistakes increases. According to the aspects described above, it is possible to provide the user U with a unique customer experience of being motivated by the performance character 60 to reduce performance mistakes, in the same manner as in aspect B1.

(2) The performance state and the content of the action condition are not limited to the examples in each of the embodiments described above. For example, the performance analysis unit 33 can detect the performance position within the target musical piece as the performance state of the user U, and the display control unit 32 can cause the performance character 60 to execute the guiding action with the action condition being that the performance position is within a specific section (hereinafter referred to as “specific section”) of the target musical piece. That is, the display control unit 32 can cause the performance character 60 to execute the guiding action when the user U is playing a specific section of the target musical piece. The content of the guiding action can be freely selected. For example, the performance character 60 executes any one of the guiding actions illustrated above, during the performance of a specific section.

A specific section is any one of a plurality of structural sections obtained by dividing the target musical piece on a time axis in accordance with musical meaning, for example. Structural sections are sections such as intro, verse, bridge, chorus, and outro. In addition, specific sections can be set in accordance with a past performance by the user U. For example, sections in which the user U made performance mistakes in the past, or sections successfully played by the user U in the past, can be set as specific sections. Sections specified by the user U through an operation on the operation device 24 can be set as specific sections.

In the configuration described above, the performance character 60 executes the guiding action when the user U is playing the specific section of the target musical piece, so that the attention of the user U can be drawn to the specific section of the target musical piece. That is, it is possible to provide the user U with a unique customer experience of being able to ascertain that the user is playing a specific section of the target musical piece through the guiding action of the performance character 60.

(3) In the above-mentioned embodiments, the information processing system 20 comprises the sound generation device 25 and the sound output device 26, but the sound generation device 25 and the sound output device 26 can be provided in the performance device 10. That is, an electronic instrument comprising the sound generation device 25 and the sound output device 26 can be used as the performance device 10.

(4) In the above-mentioned embodiments, the performance state of the user U is analyzed from the time series of the performance data P generated by the performance device 10, but the method by which the performance analysis unit 33 analyzes or configures the performance state can be freely selected, and is not limited to the examples in each of the embodiments described above. For example, in an embodiment in which performance sounds generated from a musical instrument performed by the user U are collected by a sound collection device, the audio signal generated by the sound collection device is used to analyze the performance state. In addition, in an embodiment in which the performance by the user U is captured by an imaging device, the performance analysis unit 33 uses an image signal generated by the imaging device to analyze the performance state. Additionally, the performance state can be analyzed using various sensors that detect the actions of the user U.

(5) In the above-mentioned embodiments, a configuration is shown in which one performance character 60 is displayed on the display device 23 when one user U is performing, but the display control unit 32 can display, on the display device 23, a plurality of performance characters 60 corresponding to different performance parts of the target musical piece. For example, each performance character 60 plays a different musical instrument. The display control unit 32 controls the actions of each of the plurality of performance characters 60. For example, the display control unit 32 controls the direction of the line of sight L of each of the performance characters 60.

For example, the display control unit 32 controls the line of sight L of each of the plurality of performance characters 60 to be directed toward the observation point Q in the virtual space. That is, a state is realized in which the lines of sight L of the plurality of performance characters 60 are directed toward the virtual user U in the virtual space. The direction of the lines of sight L of the plurality of performance characters 60 is not limited to the direction of the observation point Q. The direction of the line of sight L each of the performance characters 60 (for example, the performance character 60 to which the line of sight L should be directed) can be set in advance for each of the performance characters 60 following a prescribed rule. For example, the lines of sight L of the other performance characters 60 are directed toward the performance character 60 corresponding to a solo performance part, from among a plurality of performance parts of the target musical piece.

In addition, the display control unit 32 (second action control unit 322) can control the action of each of the plurality of performance characters 60 in accordance with whether an action condition relating to the performance state is met, for example. For example, when the performance by the user U stops for a prescribed period of time, the display control unit 32 controls the lines of sight L of the plurality of performance characters 60 in the direction of the observation point Q. That is, a situation is realized in which the plurality of performance characters 60 all stare at the user U when the user U hesitates to play.

(6) In the above-mentioned embodiments, a configuration is shown in which one performance character 60 is displayed on the display device 23 when one user U is performing, but each of the above-mentioned embodiments can be similarly applied to situations in which a plurality of users U perform with each other in parallel. For example, in a situation in which a plurality of users U perform different performance parts of a target musical piece, one performance character 60 is displayed on the display device 23 used by each of the users U. For example, a plurality of observation points Q corresponding to the different users U are set in the virtual space, and the display device 23 of each of the users U displays a guide image G that captured the virtual space from the observation point Q corresponding to the user U.

The display control unit 32 (second action control unit 322) sets the direction of the line of sight L of the performance character 60 to the direction of a reference point set in the virtual space. In addition, the display control unit 32 controls the direction of the line of sight L of the performance character 60 to be directed in any one of a plurality of observation points Q in the virtual space. That is, a state is reproduced in which the head and the line of sight L of the performance character 60 are turned toward any one of the plurality of virtual users U in the virtual space.

Specifically, the display control unit 32 controls the performance character 60 such that the line of sight L of the performance character 60 is directed toward the observation point Q of, from among the plurality of users U, the user U whose performance state satisfies a prescribed action condition. The action condition is, for example, the performance state being a solo performance. That is, the display control unit 32 directs the line of sight L of the performance character 60 toward the observation point Q of the user U corresponding to a solo performance part, from among a plurality of performance parts, for example. That is, the performance character 60 executes an action of turning the head and the line of sight L toward, of the plurality of users U, the user U in charge a specific performance part.

In addition, the display control unit 32 can control the action of the performance character 60 in accordance with the skill of the performance of each of the users U. For example, the performance analysis unit 33 compares the music data M of the target musical piece and the performance data P of each of the users U to calculate an evaluation score for each of the users U. The evaluation score is an index related to the skill of the performance of the user U. The display control unit 32 directs the line of sight L of the performance character 60 toward the observation point Q corresponding to, of the plurality of users U, the user U with the lowest or highest evaluation score.

The method of selecting, from among a plurality of observation points Q, the observation point Q to which the line of sight L of the performance character 60 is directed, is not limited to the example described above and can be freely selected. In addition, in a situation in which a plurality of users U corresponding to different performance parts perform in parallel, a plurality of performance characters 60 corresponding to the different performance parts can be displayed on the display device 23.

(7) In the above-mentioned embodiments, an example was shown in which the virtual instrument 50 played by the performance character 60 is a keyboard instrument, but the type of the virtual instrument 50 is not limited to a keyboard instrument. For example, any type of musical instrument, such as a string instrument, a wind instrument, or a percussion instrument, can be displayed as the virtual instrument 50 played by the performance character 60. Note that the display of the virtual instrument 50 can be omitted.

(8) In the second embodiment, the display unit 70 can be provided with an imaging device that captures an image in front (that is, the direction of the observation line of sight) of the head of the user U in real space. The display control unit 32 displays the virtual instrument 50 and the performance character 60 on the display device 72 against a background of an image of real space captured by the imaging device. That is, the display control unit 32 displays the virtual instrument 50 and the performance character 60 by means of augmented reality (AR) or mixed reality (MR).

(9) In the second embodiment, a transmissive display panel that transmits light arriving from real space can be used as the display device 72 of the display unit 70. That is, the virtual instrument 50 and the performance character 60 can be displayed against the background of an optical image formed by light arriving from real space.

(10) The information processing system 20 can be realized by a server device that communicates with the performance device 10 via a communication network. The information processing system 20 generates a guide image G in accordance with the performance data P supplied from the performance device 10, and transmits the image data of the guide image G to an information device of the user U. An information device is a device such as a smartphone or a personal computer, and displays a guide image G in accordance with the image data received from the information processing system 20. The display device 23 of the display unit 70 mounted on the head of the user U can display a guide image G in accordance with the image data received from the information processing system 20.

(11) As described above, the functions of the information processing system 20 used as an example above are realized by cooperation between one or more processors that constitute the control device 21, and a program stored in the storage device 22. The program according to the present disclosure can be provided in a form stored in a computer-readable storage medium and installed on a computer. The storage medium is, for example, a non-transitory storage medium, a good example of which is an optical storage medium (optical disc) such as a CD-ROM, but can include storage media of any known form, such as a semiconductor storage medium or a magnetic storage medium. Non-transitory storage media include any storage medium that excludes transitory propagating signals and does not exclude volatile storage media. In addition, in a configuration in which a distribution device distributes the program via a communication network, a storage medium that stores the program in the distribution device corresponds to the non-transitory storage medium.

For example, the following configurations can be understood from the embodiments exemplified above.

An information processing method according to a first aspect of the present description comprises: analyzing a state of a performance by a user in real space; displaying, on a display device, a performance character that executes a performance action in virtual space; and controlling a guiding action of the performance character in accordance with the state of the performance by the user. In the aspect described above, the guiding action of the performance character that executes a performance action in the virtual space is controlled in accordance with the state of the user's performance in real space. Therefore, the user can smoothly proceed with the performance while checking the guiding actions of the performance character. That is, it is possible to intuitively or interactively support the performance by the user.

The “performance state” is a state related to the performance of the musical instrument by the user. For example, whether the user is able to smoothly proceed with the performance, the number of performance mistakes, the progress/stoppage of the user's performance, and the like are analyzed as the “performance state.”

“Virtual space” is a virtual space realized by various information processing, such as image processing. On the other hand, “real space” is a space that actually exists in the real world, and is a concept that is contrasted with virtual space.

“Performance character” is a virtual object (agent) that plays a musical instrument in the virtual space. A specific example of a performance character would be a virtual living being such as a human being, but a “performance character” can also encompass non-biological objects such as robots. A “performance character” is a virtual user that plays a different part (that is, performs a duet) in parallel with the performance of a specific part by the user, but a “performance character” also encompasses a virtual user that performs a musical piece independently of the user's performance.

A “guiding action” of the performance character is an action of guiding the user's performance. Specifically, a guiding action is a change in the facial expression or a movement of the body (for example, posture) of the performance character. The “facial expression” of a performance character is an expression (appearance) of the state of emotion, feeling, intention, thought, or the like. “Movement of the body” and “change in the facial expression” are concepts that cannot necessarily be clearly distinguished. That is, it is possible to assume a case in which the “action” of the performance character corresponds to both “movement of the body” and “change in the facial expression.”

“Control in accordance with the performance state” means that the presence/absence of a guiding action of the performance character is linked with the state of the performance by the user. For example, the performance character executes a guiding action in response to a prescribed condition being met with respect to the state of the user's performance. As can be understood from the foregoing example, it is not necessary for the action of the performance character to be always linked with the performance state. For example, a process of temporarily changing the action of the performance character when a specific condition is met with respect to the performance state is encompassed in the “control in accordance with the performance state.”

In a specific example (a second aspect) of the first aspect, when controlling the guiding action, the performance character is caused to execute the guiding action when a prescribed condition is met with respect to the state of the performance by the user. In the aspect described above, the performance character executes a guiding action when a prescribed condition is met with respect to the user's performance. Therefore, the user can ascertain, intuitively or interactively, that a prescribed condition has been met with respect to their own performance.

“Prescribed conditions” are various conditions related to the performance state. For example, the user's performance stopping, the performance of the musical piece coming to an end, the performance proceeding smoothly, and there being many performance mistakes, are examples of prescribed conditions.

In a specific example (a third aspect) of the second aspect, the prescribed condition includes the performance stopping for a prescribed period of time. In the aspect described above, when the user's performance stops, the line of sight of the performance character moves toward an observation point. Therefore, the user can ascertain, intuitively or interactively, that the performance should proceed.

In a specific example (a fourth aspect) of the second aspect, the prescribed condition includes the performance coming to an end. In the aspect described above, the performance character executes a guiding action when the user's performance ends. Therefore, the user can ascertain, intuitively or interactively, the end of the performance.

In a specific example (a fifth aspect) of any one of the first aspect to the fourth aspect, the guiding action includes an action of the performance character moving the line of sight toward an observation point in the virtual space. In the aspect described above, when a prescribed condition is met with respect to the performance state, the line of sight of the performance character moves toward the observation point. That is, the performance character glances at the user. Therefore, the user can ascertain, intuitively or interactively, that there is something to be noted about the performance.

An “observation point” is a point in the virtual space where a viewpoint is set. That is, an image of the virtual space observed from the observation point is displayed on the display device. Specifically, the location where a virtual camera is placed in the virtual space is the “observation point.”

When the performance character has one or more eyes, a “line of sight” of the performance character is a straight line that extends in the direction in which said eyes are directed. In a state in which the line of sight of the performance character is directed toward the observation point, a viewer (for example, the user) of the display image perceives that the performance character is gazing at the viewer. The movement of the line of sight of the performance character is one example of a process for controlling the facial expression of the performance character.

In a specific example (a sixth aspect) of any one of the first aspect to the fifth aspect, the guiding action includes an action of signaling the start of the performance of a musical piece by the user. In the aspect described above, the performance character signals the start of the performance of the musical piece. Therefore, the user can ascertain, intuitively or interactively, when the performance should be started. Note that “start of the performance” includes, in addition to a case in which the performance is started at the beginning of a musical piece, a case in which the performance is restarted after a long rest in the middle of the musical piece.

In a specific example (a seventh aspect) of any one of the first aspect to the sixth aspect, the performance action is an action in which the performance character plays a second part other than a first part of a musical piece so as to follow the performance of the first part of the musical piece by the user. In the aspect described above, the performance character plays the second part so as to follow the performance of the first part by the user. Therefore, it is possible to cause the user to perceive the sensation as if the user is playing an ensemble or a duet with the performance character.

In a specific example (an eighth aspect) of any one of the first aspect to the seventh aspect, when controlling the guiding action, the performance character is caused to execute the guiding action when the user is playing a specific section of a musical piece. According to the aspect described above, the performance character executes a specific action when a specific section of the musical piece is being played, so that the attention of the user can be drawn to the specific section of the musical piece.

A “specific section” is any one of a plurality of structural sections obtained by dividing a musical piece on a time axis in accordance with musical meaning, for example. Structural sections are sections such as intro, verse, bridge, chorus, and outro. In addition, “specific sections” can be set in accordance with a past performance by the user. For example, sections in which the user made performance mistakes in the past, or sections successfully played by the user in the past, can be set as “specific sections.”

In a specific example (a ninth aspect) of any one of the first aspect to the eighth aspect, when controlling the guiding action, a guiding action of the performance character is further controlled in accordance with a line of sight of the user in the virtual space.

In a specific example (a tenth aspect) of the ninth aspect, when controlling the guiding action, the performance character is caused to execute, as the guiding action, an action of moving the line of sight of the performance character toward the user in the virtual space, when a state in which the line of sight of the user is directed toward the performance character in the virtual space has continued for a prescribed period of time.

In a specific example (an eleventh aspect) of the ninth aspect or the tenth aspect, the performance character has a head, and when controlling the guiding action, the performance character is caused to execute, as the guiding action, an action of swinging the head when the line of sight of the user swings.

In a specific example (a twelfth aspect) of the eleventh aspect, the performance by the user is the performance of a first part of a musical piece, and the method further comprises controlling a reproduction of a musical sound of a second part other than the first part of the musical piece, and controlling the rate of progress of the reproduction of the second part in accordance with the period of the swinging of the line of sight of the user, when controlling the reproduction.

An information processing system according to another aspect (a thirteenth aspect) of the present description comprises: a performance analysis unit for analyzing a state of a performance by a user in real space; and a display control unit for displaying, on a display device, a performance character that performs in virtual space, and controlling an action of the performance character in accordance with the state of the performance by the user.

A program according to another aspect (a fourteenth aspect) of the present description causes a computer system to function as: a performance analysis unit for analyzing a state of a performance by a user in real space; and a display control unit for displaying, on a display device, a performance character that performs in virtual space, and controlling an action of the performance character in accordance with the state of the performance by the user.

What is claimed is:

1. An information processing method realized by at least one processor of a computer system, the method comprising:
analyzing a state of a performance by a user in real space;
displaying, on a display device, a performance character that executes a performance action in virtual space; and
controlling a guiding action of the performance character in accordance with the state of the performance by the user.

2. The information processing method according to claim 1, wherein
the performance character is caused to execute the guiding action in a state where a prescribed condition is met with respect to the state of the performance by the user.

3. The information processing method according to claim 2, wherein
the prescribed condition includes the performance stopping for a prescribed period of time.

4. The information processing method according to claim 2, wherein
the prescribed condition includes the performance coming to an end.

5. The information processing method according to claim 1, wherein
the guiding action includes an action of the performance character moving a line of sight toward an observation point in the virtual space.

6. The information processing method according to claim 1, further comprising
the guiding action includes an action of signaling start of the performance of a musical piece by the user.

7. The information processing method according to claim 1, wherein
the performance action is an action in which the performance character plays a second part other than a first part of a musical piece so as to follow the performance of the first part of the musical piece by the user.

8. The information processing method according to claim 1, wherein
the performance character is caused to execute the guiding action in a state where the user is playing a specific section of a musical piece.

9. The information processing method according to claim 1, wherein
the guiding action of the performance character is further controlled in accordance with a line of sight of the user in the virtual space.

10. The information processing method according to claim 9, wherein
the performance character is caused to execute, as the guiding action, an action of moving the line of sight of the performance character toward the user in the virtual space, when a state in which the line of sight of the user is directed toward the performance character in the virtual space has continued for a prescribed period of time.

11. The information processing method according to claim 9, wherein
the performance character has a head, and
the performance character is caused to execute, as the guiding action, an action of swinging the head in a state where the line of sight of the user swings.

12. The information processing method according to claim 11, wherein
the performance by the user is a performance of a first part of a musical piece, and
the method further comprises
controlling a reproduction of a musical sound of a second part other than the first part of the musical piece, and
controlling a rate of progress of the reproduction of the second part in accordance with a period of the swinging of the line of sight of the user.

13. An information processing system comprising:
a controller including memory storing instructions and at least one processor that implements the instructions, the instructions comprising
analyzing a state of a performance by a user in real space; and
displaying, on a display device, a performance character that performs in virtual space, and
controlling an action of the performance character in accordance with the state of the performance by the user.

14. The information processing system according to claim 13, wherein
the performance character is caused to execute the guiding action in a state where a prescribed condition is met with respect to the state of the performance by the user.

15. The information processing system according to claim 13, wherein
the guiding action includes an action of the performance character moving a line of sight toward an observation point in the virtual space.

16. The information processing system according to claim 13, wherein
the guiding action of the performance character is further controlled in accordance with a line of sight of the user in the virtual space.

17. A non-transitory computer-readable storage medium storing a program executable by at least one processor of a computer system to perform an information processing method, the information processing method comprising
analyzing a state of a performance by a user in real space; and
displaying, on a display device, a performance character that performs in virtual space, and
controlling an action of the performance character in accordance with the state of the performance by the user.

18. The non-transitory computer-readable storage medium according to claim 17, wherein
the performance character is caused to execute the guiding action in a state where a prescribed condition is met with respect to the state of the performance by the user.

19. The non-transitory computer-readable storage medium according to claim 17, wherein
the guiding action includes an action of the performance character moving a line of sight toward an observation point in the virtual space.

20. The non-transitory computer-readable storage medium according to claim 17, wherein
the guiding action of the performance character is further controlled in accordance with a line of sight of the user in the virtual space.
